(19) United States
(12) Patent Application Publication
(10) Pub. No.: US 2023/0056624 A1
(43) Pub. Date: Feb. 23, 2023

(54) COMPUTER NETWORK IMPLEMENTED ARRANGEMENT OF ROADSIDE DELIVERIES

(71) Applicant: International Business Machines Corporation, Armonk, NY (US)

(72) Inventors: Shailendra Moyal, Pune (IN); Shilpa Bhagwatprasad Mittal, Pune (IN); Sarbajit K. Rakshit, Kolkata (IN); Venkata Vara Prasad Karri, Visakhapatnam (IN)

(21) Appl. No.: 17/407,579

(22) Filed: Aug. 20, 2021

(51) Int. Cl. G06Q 10/08

(52) U.S. Cl. CPC G06Q 10/083

(57) ABSTRACT

A computer implemented system is used to implement a “roadside delivery” (see definition, herein). These deliveries involve two vehicles (for example, trucks, unmanned aerial vehicles). One vehicle delivers a Product (see definition, herein) from the supplier side. The other vehicle is the customer's vehicle, which receives the roadside delivery of the Product pursuant to the time and location scheduled through a computer network.

### BACKGROUND

The present invention relates generally to the field of physical package delivery, and more particularly to computer network implemented physical product ordering.

For purposes of this document, “roadside delivery” shall be defined as any delivery of products or services (herein collectively referred to as “Products”), where the provider of the Products meets the recipient of the products schedule to meet, and typically to deliver, the Products at a place other than a building structure (for example, a residence, an office building). Various instances of roadside delivery involving motor vehicles will typically take place in the vicinity of drivable road(s) (for example, in a parking lot), but not all instances of “roadside delivery” necessarily require drivable roads. For example, if two unmanned aerial vehicles do a product exchange in mid-air, halfway between the supplier's warehouse and the recipient's residence, then this would be considered as a “roadside delivery” for purposes of this document. One common and familiar example of roadside delivery is when an automobile service organization delivers parts, services and/or gasoline to a vehicle stranded at the side of the road. There may or may not be inhabited and/or uninhabited buildings at the situs of a roadside delivery.

### SUMMARY

According to an aspect of the present invention, there is a method, computer program product and/or system that performs the following operations (not necessarily in the following order): (i) a new order for delivery of a product and/or service (PAOS) to a customer, with the new order including at least the following information: (a) identity of a customer entity, (b) identity of the PAOS being ordered, (c) an identification of a supplier entity, (d) time/date to effect transfer of the PAOS, and (e) identity of a location for roadside delivery location; and (ii) instructing the supplier entity's delivery vehicle to perform delivery of the PAOS at the roadside delivery location at the date/time specified in the new order.

According to an aspect of the present invention, there is a method, computer program product and/or system that performs the following operations (not necessarily in the following order): (i) a new order for delivery of a product and/or service (PAOS) to a customer, with the new order including at least the following information: (a) identity of a customer entity including identification of a customer land vehicle to be used to receive delivery of the PAOS, (b) identity of the PAOS being ordered, (c) an identification of a supplier entity, (d) time/date to effect transfer of the PAOS, and (e) identity of a location for roadside delivery location; (ii) instructing a delivery land vehicle of the supplier entity to perform delivery of the PAOS at the roadside delivery location at the date/time specified in the new order; (iii) confirming an identity of the customer entity at the roadside delivery location; and (iv) responsive to confirmation of the customer entity at the roadside delivery location, delivering the PAOS from the delivery land vehicle to the customer land vehicle at the roadside delivery location.

According to an aspect of the present invention, there is a method, computer program product and/or system that performs the following operations (not necessarily in the following order): (i) a new order for delivery of a product and/or service (PAOS) to a customer, with the new order including at least the following information: (a) identity of a customer entity including identification of a customer land vehicle to be used to receive delivery of the PAOS' (b) identity of the PAOS being ordered. (c) an identification of a supplier entity, (d) time/date to effect transfer of the PAOS', and (e) identity of a location for roadside delivery location; (ii) instructing a delivery aerial vehicle of the supplier entity to perform delivery of the PAOS at the roadside delivery location at the date/time specified in the new order; (iii) confirming an identity of the customer entity at the roadside delivery location; and (iv) responsive to confirmation of the customer entity at the roadside delivery location, delivering the PAOS from the delivery aerial vehicle to the customer land vehicle at the roadside delivery location.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a flowchart showing a second embodiment of a method according to the present invention.

### DETAILED DESCRIPTION

In some embodiments of the present invention, a computer implemented system is used to implement a “roadside delivery” (see definition, above). These deliveries involve two vehicles (for example, trucks, unmanned aerial vehicles). One vehicle delivers a Product (see definition, above) from the supplier side. The other vehicle is the customer's vehicle, which receives the roadside delivery that was scheduled through a computer network. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

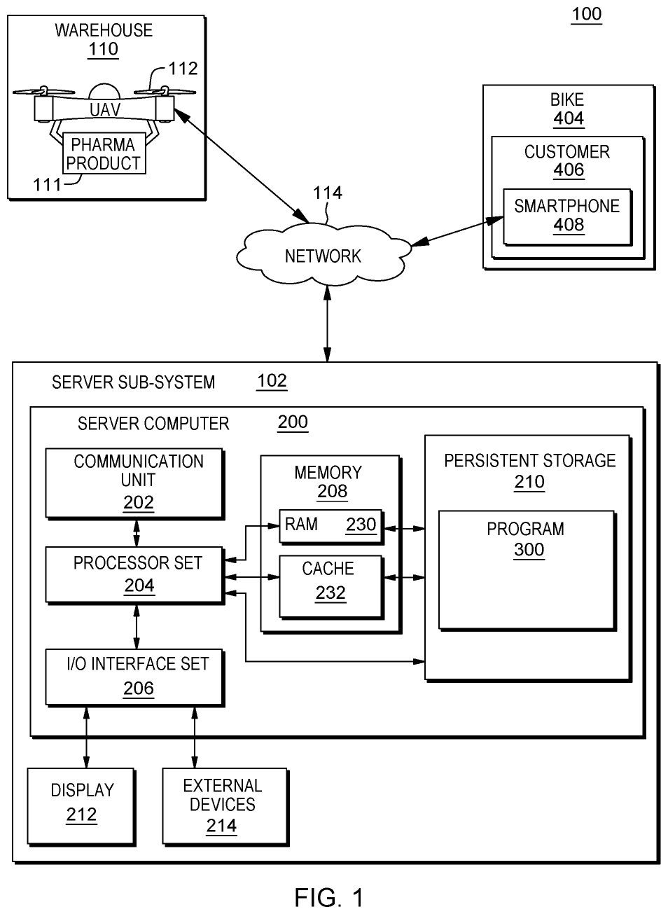

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); warehouse 110 (including unmanned aerial vehicle (UAV) 112 and pharma product 111); and bicycle (or bike) 404 (including customer 406 and smartphone 408 and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

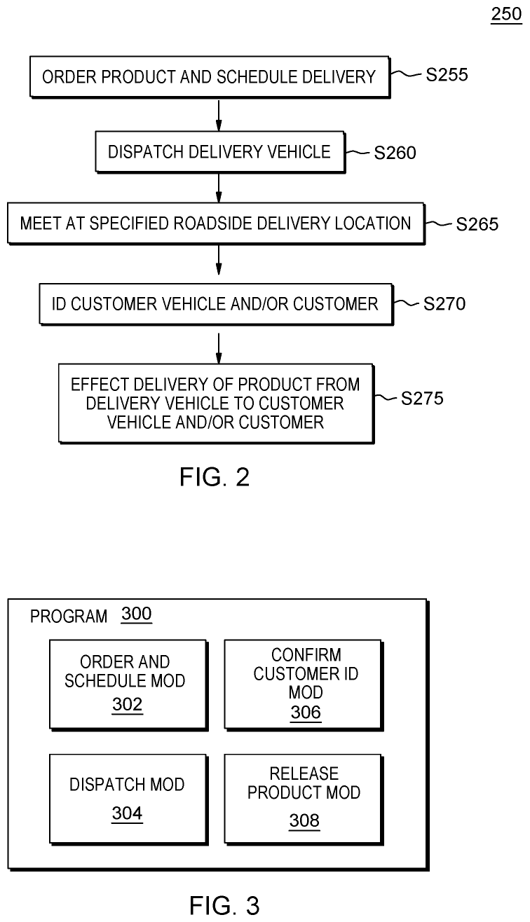

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Before launching into the method of flowchart 250, some information on this illustrative example will be provided. In this example, the customer (that is, customer 406) is a medical doctor who is going to visit a sick patient on her bike 404. The patient needs medicine (that is pharma product 111), but the doctor does not have the medicine. The method to be set forth in the following paragraphs shows how the doctor schedules the medicine to be picked up at an intermediate location along the route to the patient's residence. More specifically, the medicine will be delivered from warehouse 110 to the doctor and her bike by UAV 112.

Processing begins at operation S255, where order and schedule module (“mod”) 302 receives a new order for roadside delivery. This order comes from/through a process of a three way network communication between UAV 112, order and schedule mod 302 of server subsystem 102 and the customer's smartphone 408. The new order includes values for at least the following four parameters: (i) identity of customer (this can include direct identity of the customer (for example, by biometrics), indirect identification of the customer through identification of the user's computer device and/or indirect identification through identification of the customer's vehicle); (ii) identity of the Product being ordered (including any quantity term); (iii) an identification of the supplier; (iv) time/date to effect transfer of Product; and (v) location for roadside delivery (which is where the supplier's vehicle will meet the customer's vehicle to effect the delivery).

In this embodiment, this three way exchange of information involves: (i) information entry screens on smartphone 408 that form part of a user interface to get information from the user (such as identifying info, like a password and what Product the customer wants to purchase); (ii) machine logic in UAV 112 that can provide information on available Products and available delivery locations and times with respect to the various products inventoried at warehouse 110; and (iii) machine logic of mod 302 that queries for, receives and assembles the various parameters of the new order being placed by the customer. It is noted that the term “three way communication” here does not mean that all three involved parties take part in all of the exchanges of information in operation S255. Rather, to put it roughly, mod 302 has separate conversations with UAV 112 (supplier side) and customer 406 (customer side).

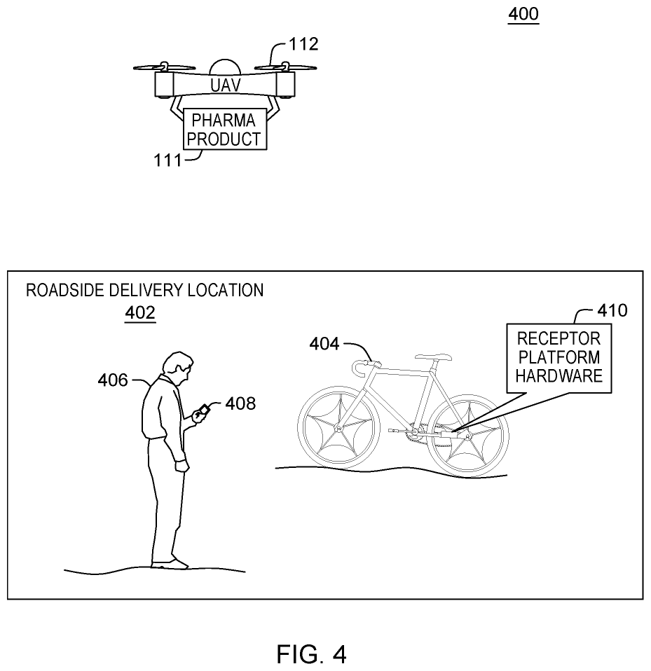

Moving to the new order being used in this illustrative example, the parameter values of the new order received and assemble by mod 302 are: (i) identity of customer is customer 406, as identified by password data and also as associated through her customer account with a security device built into receptor platform hardware 410, built into bike 404 (see screenshot 400 of FIG. 4); (ii) identity of the Product is pharmaceutical product 111, which is a packet holding two pills; (iii) the supplier is the pharmaceutical supply company that owns and controls warehouse 110 (that is, where the pills are); (iv) the time/date to effect transfer of Product is 22 Jul. 2030 at 11:45 (plus or minus five minutes); and (v) the location for roadside delivery is roadside delivery location 402 (see FIG. 4).

Processing proceeds to operation S260, where dispatch mod 304 dispatches the supplier's vehicle to meet for the roadside delivery at roadside delivery area 402 at 11:45 on 22 Jul. 2030. In order to make the delivery at this time, the UAV is dispatched from warehouse 110 by mod 304 at 11:30 and is instructed to fly at medium speed.

Processing proceeds to operation S265, where the supplier vehicle and the customer vehicle come into close proximity in order to transfer the Product. In this embodiment, the Product is the two pills, which are one type of physical product. Alternatively, the Product could take the form of services, or a combination of good and services. For example, in another example, the UAV comes and applies grease to the bike chain of the customer's bike. The physical product in that example is the grease and the service is the application of the grease to the chain. This meeting between supplier vehicle and customer vehicle is happening in FIG. 4, where UAV 112 is descending with the pills to find and attempt to engage with receptor platform hardware 410 of bike 404. This operation may involve exchange of positional information among and between smartphone 408, a processor in receptor platform hardware 410 and/or UAV 112.

In this example, the time at which UAV 112 approaches receptor platform hardware is 11:44 on 22 Jul. 2030, as specified in the new order. In this example, this approach occurs in 402 roadside delivery location, which is along the doctor's (that is, customer 406) route to her patient's house. In this embodiment, the agreed upon delivery site is chosen largely because it: (i) included a suitable place to park the bike and to send the UAV; and (ii) it was on, or near, the route that the doctor was travelling. This made the doctor's day more time efficient and is allowing her to get the medicine to her patient more quickly. In other embodiments involving UAVs, there may be a different motivation to choose a roadside delivery location. This motivation would be deliveries to customers who do not want, and/or are not allowed to have, UAVs flying to their residence and/or office. For example, in one possible embodiment, the roadside delivery locations may be parking places in a generally disused parking lot—for a small fee customer's can get a parking space and wait for their UAV delivery in a location where it will not be bothersome to the neighbors and/or co-workers.

Processing proceeds to operation 270, where confirm customer identification mod 306 confirms that the appropriate customer is present at the roadside delivery location. In this example, because the Product is medicine, there is a relatively high degree of security in regard of this confirmation of ID (identification) operation S270. More specifically, the identification is confirmed by having the UAV physically dock with receptor platform hardware 410 so that the UAV and platform are in a highly reliable form of data communication, and the UAV communicates with a processor in the platform to determine that the platform belongs to customer 406 and also that customer 406 is a medical doctor who is allowed to handle pharmaceutical product 111. In this embodiment it is the customer's vehicle (that is, a part of the bike) that is fundamentally identified by the supplier's delivery vehicle (that is, the UAV). Alternatively or additionally, the person of the customer may form the basis for making an identification that is reliable and secure enough given factors like the value of the Product being delivered. In this example, the two pills of pharmaceutical product 111 are not that valuable and can't be re-sold on an open market, but a lot of security is required because the pills could harm somebody if misused.

Processing proceed to operation 5275 where delivery of pharmaceutical product 111 is delivered from a supplier vehicle to a customer/customer vehicle at a “roadside delivery location” that was arranged over a computer network using release product mod 308. This is unlike currently conventional technology, where delivery locations of Products are typically limited to residences, offices, businesses and/or post office boxes located in post office buildings.

The subject of types of vehicles that can be used in conjunction with the present invention will now be discussed. In the example above, the supplier vehicle is a UAV and the customer vehicle is a human powered land vehicle. However, any sort of vehicle can be used as the supplier vehicle and any sort of vehicle can be used on the customer side. In many embodiments, the supply side vehicle will be a truck, because this type of vehicle is suited to carry heavy and/or bulky products. In many embodiments, the customer side vehicle will be the customer's personally owned automobile or small truck. Other, more fanciful types of vehicles could be used, at least in theory, such as horses or pogo sticks or boats (it is noted that, under the definitions provided above, even a meeting of boats in the water will still be an example of a “roadside delivery location”). Either or both vehicles may be unmanned and/or driverless. For example, in one embodiment, a large central warehouse has a vast and sprawling parking lot outside of it, and driverless delivery vehicles deliver from the warehouse, through the parking lot and to the customer's parked vehicle — curbside service, but at a warehouse scale with respect to variety of products available.

### III. Further Comments and/or Embodiments

Some embodiments of the present invention recognize the following facts, potential problems and/or potential areas for improvement with respect to the current state of the art: (i) as per existing online ordering methods, the products are delivered to your home; (ii) in many situations, the products can also be delivered along the way to the customer such as the product is delivered while the customer is travelling towards his/her office location; (iii) based on a dynamic location of the user, the product can be delivered to the customer's real-time position (that is, the customers real-time location is identified and then the product is delivered); and/or (iv) the products and packages can have various dimensions.

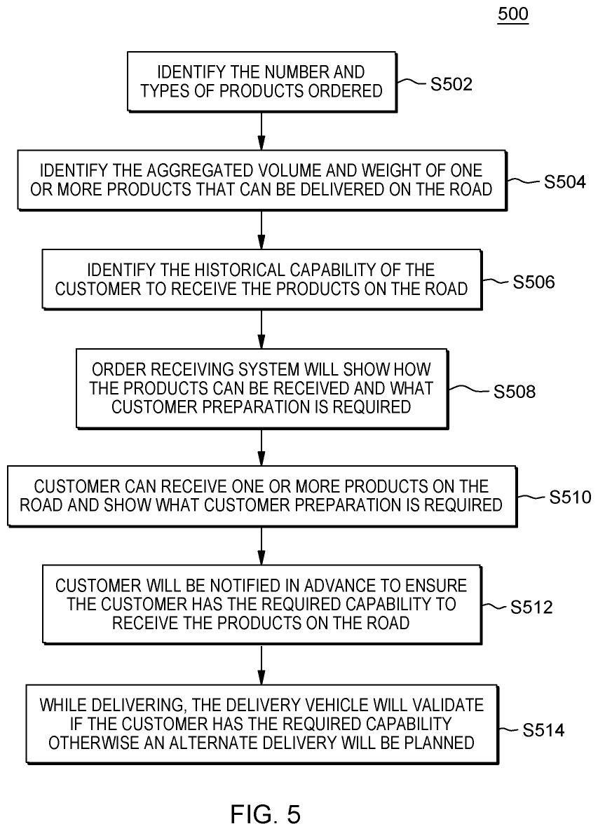

An embodiment of a method according to the present invention is represented by flowchart 500 of FIG. 5. The method of flowchart 500 includes the following operations: S502, S504, S506, S508, S510, S512, and S514. Process flow among and between the operations is as shown by arrows in FIG. 5.

Apart from predicted the carrying capability of the customer from historical learning, some embodiments can also gather realtime feed from the vehicles. This allows the logistics software of the delivery entity to know the carrying capacity for the time being, like the boot space of one of a fleet of delivery vehicles that is already partially filled, so the actual available space will be identified in time for it to be used with a product that will fit well into the space of the delivery vehicle and its overall schedule for making all of its deliveries.

Some examples of what is discussed in the preceding paragraph will now be set forth: (i) the customer entity can proactively be notified about the required available space; and (ii) based on available space, the system prioritizes which products can be sent to the customer during any given point (or range) in date/time.

Some embodiments of the present invention recognize the following facts, potential problems and/or potential areas for improvement with respect to the current state of the art: (i) in many situations, the customer may not have enough storage capacity to accept additional packages being delivered at the same time: (ii) the customer can have insufficient capacity to store additional packages (for example, a user is driving in a vehicle, and there is not enough space to accommodate the additional delivered package; (iii) at the same time, the dimension of the delivered package may be dimensionally too large to accommodate the package in the vehicle; (iv) the customer is already occupied with various items, and carrying or storing delivered packages can be a problem; and/or (v) people have to wait at home to receive their parcel or ask their neighbors to accept them.

Some embodiments of the present invention may include one, or more, of the following operations, features, characteristics and/or advantages: (i) customer experience is always a top priority to businesses and the reason is simple—the companies that focus on customer experience reduce churn and increase revenues, leading to higher profits; (ii) for many, customer service and customer experience are seemingly interchangeable; (iii) considering items (i) and (ii) above, one is a single touchpoint with a brand, while the other impacts feelings, emotion, and encompasses the entire customer journey; (iv) the customer experience impacts all areas of the business; and/or (v) companies who successfully implement a customer experience strategy achieve higher customer satisfaction rates, reduced customer churn, and increase revenue.

Some embodiments of the present invention may include one, or more, of the following operations, features, characteristics and/or advantages: (i) receiving a parcel while going to the office without waiting back at home and wasting time: (ii) while ordering any package, the product can be delivered to the customer while the customer is on his/her journey; (iii) the capability of the customer to receive and carry the delivered package will be validated; and/or (iv) accordingly, the product will be delivered to the customer.

Some embodiments of the present invention may include one, or more, of the following operations, features, characteristics and/or advantages: (i) while ordering product online, the shopping system will calculate dimensions, shape and weight of one or multiple packages, and accordingly show an option on how the product can be received on the road; (ii) the system will show the different possible capabilities required to receive the package on the road and the customer can select one or more options to receive the packages while on the road; (iii) based on the dimensions, the shape, and weight of the packages that are scheduled to be delivered on the road, the remote shopping system will proactively notify the customer to ensure the required capability is maintained so that the packages can be received on the road; (iv) based on the selection of having an order received on the road, the delivery system will be performing contextual analysis about the customer situation (for example, camera, IoT (internet of things), wearable feed, etc.), available capacity, etc. to identify if the customer can receive the products on the road and can carry them; and/or (v) accordingly, the delivery system will also recommend an alternate mode of delivery, if needed, so that the products can be delivered safely.

Some embodiments of the present invention may include one, or more, of the following operations, features, characteristics and/or advantages: (i) the system will make use of vehicle sensor data with user consent to calculate the total capacity and available capacity in the car; (ii) the system will automatically notify the user if capacity is adequate, that is, will the package fit or not fit; (iii) vehicle sensor data, with user consent, will be used to calculate the total capacity and available capacity with other attributes, such as load capacity at the present location; (iv) the system will use real time data; and/or (v) if the customer does not have the required capability while receiving product on road, the delivery vehicle will have voice interaction with the customer and, using a two-way voice interaction alternate mode, the delivery will be planned.

Some embodiments of the present invention may include one, or more, of the following operations, features, characteristics and/or advantages: (i) while receiving product on the road, or from a mobile location, the customer can also provide additional instructions on order receiving; (ii) the system will perform natural language processing of the additional instructions; (iii) the system will proactively arrange the product for delivery on the road (for example, after returning from the airport, the customer has instructed the system that the customer will hire a vehicle to take the delivery, and wants to receive the package in the hired vehicle); and/or (iv) there will be communication between the customer and the delivery system before the customer heads towards the destination so that the delivery system will initiate the delivery.

Some embodiments of the present invention may include one, or more, of the following operations, features, characteristics and/or advantages: (i) based on historical learning about the capability of the customer to receive the package, the system will suggest to the user on how the customer can receive the product, and the same information will be shown while ordering the product online; (ii) the system uses machine learning techniques, such as multi-classification algorithms, to classify the packages based on their dimensions, type, shape, etc.; (iii) using a historical delivery mode, the delivery timeline, customer feedback, and the arrangement of packages in the delivery bag, the road delivery schedule is planned and suggested to the delivery agents daily (or as per the vendor side timelines) to assure optimal delivery; and/or (iv) the system, using a reinforcement algorithms, will learn the feedback of the customer with respect to the delivery mode, and accordingly will create a data model for different items, modes of delivery, and region.

According to some embodiments of the present invention, FIG. 5, flowchart 500 talks about, while ordering product online, how the system will evaluate how much capability is required for the customer to receive the product. This flowchart is helpful in understanding embodiments of the present invention.

A method according to an embodiment of the present invention includes the following operations (not necessarily in the following order): (i) the shopping system will identify each and every product uniquely; (ii) the shopping system will identify the dimensions, shape, and weight of each product with packaging; (iii) the shopping system will also have delivery instructions for each and every product (for example, upside down is not allowed, etc.); (iv) when the customer orders online, the shopping system will identify the types of products ordered and the total order details; (v) based on the number of products ordered, the shopping system will identify the aggregated dimensions, shape, and weight of the products; (vi) the delivery system will identify how much space is required to receive the orders on the road and what the weight of the packages will be; (vii) the IoT enabled system for each customer will identify various capabilities to receive the product on the road; and (viii) the IoT enabled system will historically track if there is a passenger in the car while travelling, how much space is available, how much weight the car can carry, etc.

A method according to an embodiment of the present invention includes the following operations (not necessarily in the following order): (i) while the products are being ordered online, the order shopping system will calculate the aggregated weight, dimensions, and shapes of the package and will show options for the customer to receive the order on the road; (ii) based on the selection of receiving the products on the road, the system will show how the products can be received; (iii) the system will show various options of receiving the product on the road; (iv) the customer can select one or more options from the recommended list, and accordingly, the delivery system will plan for the selected mode of delivery; (v) the customer's personalized system can also recommend how the products can be received on the road; (vi) based on historical data from the customer's travel, the personal system will evaluate the capability of the customer to receive products on the road; and (vii) the personal recommendation system will also recommend how the products should be accepted on the road.

A method according to an embodiment of the present invention includes the following operations (not necessarily in the following order): (i) the personal recommendation system will also recommend how the products should be accepted on the road; (ii) on the delivery date, the shopping system will proactively notify the customer to keep the required capacity available; (iii) the real time location of the customer will be tracked so the nearest intersecting point can be identified and communicated to the customer, so that the customer doesn't have to wait on the road for the delivery; (iv) the time difference between the customers starting point and the customers destination, along with the delivery system's starting point, is taken into consideration so that the product is delivered to the customer on time without any delay or wait time; (v) while ordering the product, the customer can also provide specific instructions to receive the product on the road; (vi) the specific instructions can be voice instructions, such as how the customer would like to receive the product and where the customer can receive the product; (vii) the delivery system will proactively arrange the product at the delivery location, such as with a UAV or any other system; (viii) the system will evaluate if the products can be received on the road, and if the customer has the required capacity; (ix) if the required capability is available, then the delivery system will deliver the product to the customer; and (x) if the required capacity of the customer to receive the product is not sufficient, then the customer and the delivery system can perform voice interaction to plan for an alternate delivery.

Some embodiments of the present invention may include one, or more, of the following operations, features, characteristics and/or advantages: (i) a shopping system that identifies the items being ordered; (ii) calculates the items various parameters (type, size, quantity, weight, etc.); (iii) while traveling, provides instructions to the customer, while ordering, if it is possible to get the delivery on the road, based on the vehicle being used by the customer; (iv) the delivery system identifies how much space is required to accept the delivery; (v) the system contacts the customer and enables the customer to pick up its delivery while on the road, rather than waiting for the package to get delivered to the customers provided address.

Some embodiments of the present invention may include one, or more, of the following operations, features, characteristics and/or advantages: (i) does not require customers to come and wait at a decided location but calculates the nearest meeting point when both of the vehicles are in transit; and/or (ii) can efficiently collect the placed orders based on: (a) the size of the vehicle the customer is in, (b) the item that is getting delivered, and/or (c) the route the customer and the delivery vehicle is on.

Some embodiments of the present invention may include one, or more, of the following operations, features, characteristics and/or advantages: (i) includes a system for delivering products/packages using the customer's route; (ii) during online ordering, validates the capacity of a customer's vehicle to receive and carry the delivered packages; and/or (iii) accordingly, the packages will be delivered to the customer.

Some embodiments of the present invention may include one, or more, of the following operations, features, characteristics and/or advantages: (i) enables a remote shopping module to calculate dimensions, shape, and weight of multiple packages; (ii) shows an option on how the packages can be received on the road; (iii) shows different possible capabilities required to receive the packages on the road; (iv) enables the customer to select one or more option(s) to receive the packages while on the road; (v) enables the remote shopping module to proactively notify the customer to ensure the required capacity is maintained, so that the packages can be received on the road; (vi) considers the delivery based on the required dimensions, shape, and weight of the packages to be delivered on the road; (vii) performs contextual analysis about the customer situation (for example, camera, IoT, wearable feed, etc.); (viii) performs analysis about identifying the available capacity of the customer to receive the packages on the road and if the customer can carry them; and/or (ix) a delivery module will also recommend an alternate mode of delivery so that the packages can be delivered safely.

Some embodiments of the present invention may include one, or more, of the following operations, features, characteristics and/or advantages: (i) uses vehicle sensor data, with user consent, to calculate the total capacity and available capacity in the customers vehicle; (ii) automatically notifies the customer if the capacity is not adequate for the packages to fit or not fit; and/or (iii) enables the delivery vehicle to have a voice interaction with the customer, and with two-way voice interaction, an alternate mode of delivery will be planned if the customer does not have the required capacity to receive the packages on the road.

Some embodiments of the present invention may include one, or more, of the following operations, features, characteristics and/or advantages: (i) performs natural language processing of additional instructions; (ii) proactively arranges the packages for delivery on the road or from a mobile location; (iii) recommends to the delivery agents how the customer can receive the packages, and the same will be shown while ordering the packages/products online, based on historical learning about the capability of the customer to receive the package; (iv) classifies the packages based on their dimensions, type, shape, etc., along with its historical delivery mode and delivery timeline; (v) classifies the packages based on customer feedback using machine learning techniques; (vi) the arrangement of packages in a delivery bag is based on the road delivery schedule, which is planned and suggested to the delivery agents daily, or as per the vendor side timelines, to assure optimal delivery; (vii) uses a reinforcement algorithm to learn the feedback of the customer with respect to the delivery mode; and/or (viii) creates data models for different items, different modes of delivery, and region.

In some embodiments, the method/system is mostly covering user's capacity and package capacity requirement and using it to decide on the delivery mechanism for on-road delivery.

In some embodiments, if any customer needs to collect packages, then based on boot space of the vehicle, and proper utilization of the boot space of the vehicle, the packages will be created appropriately, and will also provide notification on how the packages can be kept inside the boot space.

The customer's carrying capacity will now be discussed in this paragraph. Boot space available in the vehicle of the customer (that includes total available space — occupied space). Here, the customer is using a bike (two wheelers. etc.). The customer can take delivery of products from any delivery vehicle (for example, ordered products can be delivered through the delivery vehicle and the customer is picking the product from the delivery vehicle). This can be any product, which can be aligned with the carrying capacity of the customer, for example, the customer is using a larger SUV (sport utility vehicle), and the SUV can carry a washing machine, so he can carry the same from the delivery vehicle, or the customer is in a two wheeler and has a small basket attached with the two wheeler, so he can pick up a small item.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container.

Cloud computing system: a computer system that is distributed over the geographical range of a communication network(s), where the computing work and/or computing resources on the server side are primarily (or entirely) implemented by VCEs (see definition of VCEs in previous paragraph). Cloud computing systems typically include a cloud orchestration module, layer and/or program that manages and controls the VCEs on the server side with respect to instantiations, configurations, movements between physical host devices, terminations of previously active VCEs and the like.

What is claimed is:

1. A computer-implemented method (CIM) comprising:
a new order for delivery of a product and/or service (PAOS) to a customer, with the new order including at least the following information: (i) identity of a customer entity; (ii) identity of the PAOS being ordered; (iii) an identification of a supplier entity; (iv) time/date to effect transfer of the PAOS; and (v) identity of a location for roadside delivery location; and
instructing the supplier entity's delivery vehicle to perform delivery of the PAOS at the roadside delivery location at the date/time specified in the new order.

2. The CIM of claim 1 further comprising:
confirming an identity of the customer entity at the roadside delivery location; and
responsive to confirmation of the customer entity at the roadside delivery location, delivering the PAOS from the supplier entity's delivery vehicle to the customer entity's vehicle at the roadside delivery location.

3. The CIM of claim 2 wherein the confirmation of the identity at the roadside delivery location includes identification of at least one of the following aspects of the customer entity: a person associated with the customer entity, a customer vehicle associated the customer entity and/or a computing device associated with the customer entity.

4. The CIM of claim 1 further comprising:
collecting, from the customer entity and the supplier entity, information that makes up the new order, with the collection of information including collection of the following: (i) the identity of the customer entity, (ii) the identity of the PAOS, (iii) the identification of the supplier entity; (iv) the time/date to effect transfer of the PAOS; and (v) the identity of the roadside delivery location;
wherein the collection of the time/date to effect transfer and a decision to proceed with a roadside delivery location, as opposed to a traditional delivery location is based, at least in part, upon consideration of the following factors: (i) available space over time in a fleet of delivery vehicles, (ii) a dynamic identification of whether the PAOS is included in a definition of products that can be given to the customer entity, and (iii) whether the PAOS can be delivered at a non-roadside delivery location.

5. The CIM of claim 1 further comprising:
prioritizing among and between a plurality of products which can be delivered to the customer based on the available space with the customer entity to carry products delivered pursuant to the prioritization.

6. The CIM of claim 1 further comprising:
creating a plurality of stacks;
for each given product of a plurality of products, selecting a respectively associated stack from the plurality of stacks based on available space, and physical dimensions of the given product; and
for each given product of the plurality of products, placing the given product in its respectively associated stack;
wherein the selection of stacks is performed so that stability of the products is achieved, and the stack do not collapse under influence of movements/vibrations of delivery vehicles in which the products will respectively travel.

7. A computer-implemented method (CIM) comprising:
a new order for delivery of a product and/or service (PAOS) to a customer, with the new order including at least the following information: (i) identity of a customer entity including identification of a customer land vehicle to be used to receive delivery of the PAOS; (ii) identity of the PAOS being ordered; (iii) an identification of a supplier entity; (iv) time/date to effect transfer of the PAOS; and (v) identity of a location for roadside delivery location;
instructing a delivery land vehicle of the supplier entity to perform delivery of the PAOS at the roadside delivery location at the date/time specified in the new order;
confirming an identity of the customer entity at the roadside delivery location; and
responsive to confirmation of the customer entity at the roadside delivery location, delivering the PAOS from the delivery land vehicle to the customer land vehicle at the roadside delivery location.

8. The CIM of claim 7 wherein:
the delivery land vehicle is a delivery truck; and
the customer land vehicle is a personally owned type motor vehicle.

9. The CIM of claim 7 wherein the roadside delivery location is a parking lot.

10. A computer-implemented method (CIM) comprising:
a new order for delivery of a product and/or service (PAOS) to a customer, with the new order including at least the following information: (i) identity of a customer entity including identification of a customer land vehicle to be used to receive delivery of the PAOS; (ii) identity of the PAOS being ordered; (iii) an identification of a supplier entity; (iv) time/date to effect transfer of the PAOS; and (v) identity of a location for roadside delivery location;
instructing a delivery aerial vehicle of the supplier entity to perform delivery of the PAOS at the roadside delivery location at the date/time specified in the new order;
confirming an identity of the customer entity at the roadside delivery location; and
responsive to confirmation of the customer entity at the roadside delivery location, delivering the PAOS from the delivery aerial vehicle to the customer land vehicle at the roadside delivery location.

11. The CIM of claim 7 wherein the delivery aerial vehicle is an unmanned aerial vehicle.

12. The CIM of claim 7 wherein the roadside delivery location is a parking lot.
